(19) United States
(12) Patent Application Publication
(10) Pub. No.: US 2020/0202377 A1
(43) Pub. Date: Jun. 25, 2020

(54) USER INTERFACE FOR DETERMINING SUBSCRIPTION OFFERS THROUGH USER PURCHASE BEHAVIOR

(71) Applicant: Shopify Inc., Ottawa (CA)

(72) Inventors: George Yacoub, Unionville (CA); Corey Pollock, Toronto (CA)

(21) Appl. No.: 16/225,653

(22) Filed: Dec. 19, 2018

(51) Int. Cl. G06Q 30/02; G06Q 10/06

(52) U.S. Cl. CPC G06Q 30/0222; G06Q 10/06315; G06Q 30/0224; G06Q 30/0223

(57) ABSTRACT

A computer-implemented method and system for a user interface including retrieving e-commerce behavior data from a data facility, where the e-commerce behavior data includes customer prior purchase data based on a purchase of a product by a customer through an e-commerce platform; evaluating the e-commerce behavior data with an analytics engine to determine a plurality of subscription products to offer the customer in a product subscription offer; and displaying the product subscription offer on a computing device.

### FIELD

The present disclosure relates generally to product offerings in an e-commerce environment, and more particularly to subscription offers to e-commerce users based on past user purchase behavior and other factors.

### BACKGROUND

Subscription offers are typically generated based on products that a merchant would like to sell (e.g., products that have a periodic characteristic) or products that a customer explicitly identifies (e.g., a customer placing products in a subscription cart). However, these subscription methods have no way to predict what a user is going to actually need in the future, but are instead dependent on present needs—such as based in the moment on what a merchant wants to regularly sell or on what a customer thinks they need to regularly buy. What is needed is a way to more effectively build subscription offers.

### SUMMARY

In an aspect, a computer-implemented method may include retrieving, by an analytics engine, e-commerce data from a data facility, wherein the e-commerce data comprises at least one of customer purchase behavior data of a customer and merchant commerce data of a merchant; identifying, by the analytics engine, at least one product from the e-commerce data, wherein the at least one product has been purchased; evaluating, by the analytics engine, purchase patterns for the at least one product, wherein the purchase patterns comprises a purchase pattern periodicity for repeated purchases of the at least one product; generating a subscription offer for the at least one product; and providing a subscription offer recommendation to the merchant. In embodiments, the at least one of customer purchase behavior data of a customer and merchant commerce data of a merchant may be purchase behavior data from a plurality of customer and merchant purchase behavior data collected from commerce executed through an e-commerce platform. The subscription offer may be based on the plurality of customer and merchant purchase behavior data. The method may further include retrieving, by the analytics engine, e-commerce data from a data facility comprising first customer purchase behavior data of a first customer, wherein generating the subscription offer is based on both the plurality of customer and merchant purchase behavior data and the first customer purchase behavior data. The at least one of customer purchase behavior data of a customer and merchant commerce data of a merchant may be first customer purchase behavior data of a first customer, wherein generating the subscription offer is based on the first customer purchase behavior data. The method may further include performing, by the analytics engine, relational processing that relates the at least one product to at least a second product, and including at least the second product in the subscription offer. Identifying the at least one product may utilize language-based processing to identify a product type. Identifying the at least one product may utilize vision-based processing to identify a product type. The customer purchase behavior data may be collected from an order history of the customer. The subscription offer recommendation may be provided to the merchant as a recommendation for the merchant to offer the subscription offer to the customer. Providing the subscription offer recommendation may further send the subscription offer recommendation to the customer based on a subscription recommendation approval attribute set by the merchant.

In an aspect, a computer-implemented method may include retrieving e-commerce data from a data facility, wherein the e-commerce data comprises customer purchase behavior data of a customer and merchant commerce data of a merchant; processing the e-commerce data with an analytics engine to determine a present value for the e-commerce attribute of at least one product, wherein if the present value exceeds a threshold value then a subscription offer is generated for the at least one product, wherein the subscription offer comprises a cost discount value and sales schedule for the at least one product as offered from the merchant to the customer; and providing a subscription offer to the merchant. In embodiments, the e-commerce attribute may be a number of times the customer has purchased the at least one product. The e-commerce attribute may be a number of the at least one product currently in inventory for the merchant. The e-commerce attribute may be a number of the at least one product that is sold by the merchant. The e-commerce attribute may be a number of product transactions across an e-commerce platform. Processing the e-commerce data with the analytics engine may include detecting patterns in purchases by the customer. The e-commerce data further may include customer purchase data of a second customer, where processing the e-commerce data with the analytics engine comprises detecting patterns in e-commerce activity by the customer and the second customer.

In an aspect, a computer-implemented method may include retrieving e-commerce data from a data facility, where the e-commerce data comprises customer purchase behavior data of a customer through an e-commerce platform; evaluating the e-commerce data with an analytics engine to determine a purchase pattern within the e-commerce data for the customer; generating a subscription to offer the customer in a subscription offer based on the determined purchase pattern; and providing the subscription offer. In embodiments, the subscription offer may be provided to a merchant as a recommended subscription offer for a customer. The method may further include offering the subscription offer to the customer based on a merchant response to providing the subscription offer. The e-commerce data may further include merchant prior sale data, and the purchase pattern is determined based at least in part on a merchant sales parameter. The merchant sales parameter may be an availability parameter based on an availability of supported merchant products. The merchant sales parameter may be an inventory parameter based on an inventory of merchant products. The merchant sales parameter may be a product catalog parameter based on a catalog of merchant products. The merchant sales parameter may be based on sales of products by a merchant. The merchant sales parameter may be a reputation parameter based on a social media-based reputation of a merchant. The merchant sales parameter may be a product location parameter based on a location of a product. The merchant sales parameter may be a fulfillment parameter based on a product being sold through the e-commerce platform. The e-commerce data may further comprise merchant buying data, and the purchase pattern may be determined at least in part on the merchant buying data. A purchase of a product by the customer may be from product transactions across the e-commerce platform. A purchase of a product by the customer may be from a merchant. The method may further include providing the subscription offer to the merchant and a second merchant of the e-commerce platform, wherein the customer purchase behavior data is further based on a second purchase of a second product by the customer from the second merchant. The subscription offer may be a bundled product subscription offer based on the purchase from the merchant and the second purchase from the second merchant, and a bundled product subscription is jointly offered by the merchant and the second merchant.

In an aspect, a computer-implemented method may include retrieving e-commerce behavior data from a data facility, wherein the e-commerce behavior data comprises customer prior purchase data based on a purchase of a product by a customer through an e-commerce platform; evaluating the e-commerce behavior data with an analytics engine to determine a commerce category within the e-commerce behavior data for the customer; generating a subscription product to offer the customer in a product subscription offer based on the determined commerce category; and providing the product subscription offer to a merchant of the e-commerce platform. In embodiments, the commerce category may be based on a room in a building, such as where the room is at least one of a laundry room, kitchen, or bathroom. The commerce category may be based on an activity. The commerce category may be based on a period of time. The period of time may be at least one of a month or a season.

In an aspect, a system may include an analytics engine for retrieving e-commerce data from a data facility, wherein the e-commerce data comprises at least one of customer purchase behavior data of a customer and merchant commerce data of a merchant, the analytics engine configured to store a set of instructions that, when executed, cause the analytics engine to: identify, by the analytics engine, at least one product from the e-commerce data, wherein the at least one product has been purchased; evaluate, by the analytics engine, purchase patterns for the at least one product, wherein the purchase patterns comprises a purchase pattern periodicity for repeated purchases of the at least one product; generate a subscription offer for the at least one product; and provide a subscription offer recommendation to the merchant. In embodiments, the at least one of customer purchase behavior data of a customer and merchant commerce data of a merchant may be purchase behavior data from a plurality of customer and merchant purchase behavior data collected from commerce executed through an e-commerce platform. The subscription offer may be based on the plurality of customer and merchant purchase behavior data. The method may further include retrieving, by the analytics engine, e-commerce data from a data facility comprising first customer purchase behavior data of a first customer, wherein generating the subscription offer is based on both the plurality of customer and merchant purchase behavior data and the first customer purchase behavior data. The at least one of customer purchase behavior data of a customer and merchant commerce data of a merchant may be first customer purchase behavior data of a first customer, wherein generating the subscription offer is based on the first customer purchase behavior data. The method may further include performing, by the analytics engine, relational processing that relates the at least one product to at least a second product, and including at least the second product in the subscription offer. Identifying the at least one product may utilize language-based processing to identify a product type. Identifying the at least one product may utilize vision-based processing to identify a product type. The customer purchase behavior data may be collected from an order history of the customer. The subscription offer recommendation may be provided to the merchant as a recommendation for the merchant to offer the subscription offer to the customer. Providing the subscription offer recommendation may further send the subscription offer recommendation to the customer based on a subscription recommendation approval attribute set by the merchant.

In an aspect, a system may include an analytics engine for retrieving e-commerce data from a data facility, wherein the e-commerce data comprises customer purchase behavior data of a customer and merchant commerce data of a merchant, the analytics engine configured to store a set of instructions that, when executed, cause the analytics engine to: process the e-commerce data with an analytics engine to determine a present value for the e-commerce attribute of at least one product, wherein if the present value exceeds a threshold value then a subscription offer is generated for the at least one product, wherein the subscription offer comprises a cost discount value and sales schedule for the at least one product as offered from the merchant to the customer; and provide a subscription offer to the merchant. In embodiments, the e-commerce attribute may be a number of times the customer has purchased the at least one product. The e-commerce attribute may be a number of the at least one product currently in inventory for the merchant. The e-commerce attribute may be a number of the at least one product that is sold by the merchant. The e-commerce attribute may be a number of product transactions across an e-commerce platform. Processing the e-commerce data with the analytics engine may include detecting patterns in purchases by the customer. The e-commerce data further may include customer purchase data of a second customer, where processing the e-commerce data with the analytics engine comprises detecting patterns in e-commerce activity by the customer and the second customer.

In an aspect, a system may include an analytics engine for retrieving e-commerce data from a data facility, where the e-commerce data comprises customer purchase behavior data of a customer through an e-commerce platform, the analytics engine configured to store a set of instructions that, when executed, cause the analytics engine to: evaluate the e-commerce data with an analytics engine to determine a purchase pattern within the e-commerce data for the customer; generate a subscription to offer the customer in a subscription offer based on the determined purchase pattern; and provide the subscription offer. In embodiments, the subscription offer may be provided to a merchant as a recommended subscription offer for a customer. The method may further include offering the subscription offer to the customer based on a merchant response to providing the subscription offer. The e-commerce data may further include merchant prior sale data, and the purchase pattern is determined based at least in part on a merchant sales parameter. The merchant sales parameter may be an availability parameter based on an availability of supported merchant products. The merchant sales parameter may be an inventory parameter based on an inventory of merchant products. The merchant sales parameter may be a product catalog parameter based on a catalog of merchant products. The merchant sales parameter may be based on sales of products by a merchant. The merchant sales parameter may be a reputation parameter based on a social media-based reputation of a merchant. The merchant sales parameter may be a product location parameter based on a location of a product. The merchant sales parameter may be a fulfillment parameter based on a product being sold through the e-commerce platform. The e-commerce data may further comprise merchant buying data, and the purchase pattern may be determined at least in part on the merchant buying data. A purchase of a product by the customer may be from product transactions across the e-commerce platform. A purchase of a product by the customer may be from a merchant. The method may further include providing the subscription offer to the merchant and a second merchant of the e-commerce platform, wherein the customer purchase behavior data is further based on a second purchase of a second product by the customer from the second merchant. The subscription offer may be a bundled product subscription offer based on the purchase from the merchant and the second purchase from the second merchant, and a bundled product subscription is jointly offered by the merchant and the second merchant.

In an aspect, a system may include an analytics engine for retrieving e-commerce behavior data from a data facility, wherein the e-commerce behavior data comprises customer prior purchase data based on a purchase of a product by a customer through an e-commerce platform, the analytics engine configured to store a set of instructions that, when executed, cause the analytics engine to: evaluate the e-commerce behavior data with an analytics engine to determine a commerce category within the e-commerce behavior data for the customer; generate a subscription product to offer the customer in a product subscription offer based on the determined commerce category; and provide the product subscription offer to a merchant of the e-commerce platform. In embodiments, the commerce category may be based on a room in a building, such as where the room is at least one of a laundry room, kitchen, or bathroom. The commerce category may be based on an activity. The commerce category may be based on a period of time. The period of time may be at least one of a month or a season.

In an aspect, a computer-implemented method for a user interface may include retrieving e-commerce behavior data from a data facility, where the e-commerce behavior data comprises customer prior purchase data based on a purchase of a product by a customer through an e-commerce platform; evaluating the e-commerce behavior data with an analytics engine to determine a plurality of subscription products to offer the customer in a product subscription offer; and displaying the product subscription offer to a merchant of the e-commerce platform on a commerce user interface, where the product subscription offer is based on evaluating the e-commerce behavior data. In embodiments, the commerce user interface may be presented on a user home page of a merchant online store of an e-commerce platform. The commerce user interface may be presented to a graphical user interface on a merchant client device. The product subscription offer may provide recommendations based on the plurality of subscription products for the customer, wherein the merchant can adjust an analytics parameter for the analytics engine to adjust the recommendations. The product subscription offer may include at least a second merchant, where the product subscription offer comprises opt-in options to the merchant based on the product subscription offer including at least the second merchant. The product subscription offer may include a fulfillment commitment option for the merchant. The plurality of subscription products may include at least two products, where the at least two products are products for sale by the merchant and evaluating the e-commerce behavior data with an analytics engine determines a present value for an e-commerce attribute of the at least two products, and the product subscription offer includes the at least two products. The at least two products may be related by a usage characteristic. The usage characteristic may be the at least two products being used in a functional space within a residence. The functional space may be at least one of a laundry room, a bathroom, a kitchen, an automotive space, or a storage space.

In an aspect, a computer-implemented method may include displaying a commerce user interface for composing a product subscription, the commerce user interface displayed on a merchant client device; receiving a product subscription request from the merchant client device; retrieving e-commerce behavior data from a data facility based on the product subscription request, wherein the e-commerce behavior data comprises customer prior purchase data based on a purchase of a product by a customer through an e-commerce platform; evaluating the e-commerce behavior data with an analytics engine to determine a plurality of subscription products to offer the customer in a product subscription offer; and displaying the product subscription offer on the commerce user interface, wherein the product subscription offer is based on evaluating the e-commerce behavior data. In embodiments, the commerce user interface may be presented on a user home page of a merchant online store of an e-commerce platform. The commerce user interface may be presented to a graphical user interface on a merchant client device. The commerce user interface may include an input interface to adjust an analytics parameter for the analytics engine to adjust the evaluating the e-commerce behavior data. The commerce user interface may include an input interface for specifying products for inclusion in the product subscription offer. Evaluating the e-commerce behavior data with the analytics engine may include detecting patterns in products that are being sold by a merchant. Evaluating the e-commerce behavior data with the analytics engine may include detecting patterns in products that are in inventory by a merchant. The customer prior purchase data may be collected from a post purchase care facility that stores customer product purchase information.

In an aspect, a computer-implemented method for a user interface may include retrieving e-commerce behavior data from a data facility, where the e-commerce behavior data comprises customer prior purchase data based on a purchase of a product by a customer through an e-commerce platform; evaluating the e-commerce behavior data with an analytics engine to determine a plurality of subscription products to offer the customer in a product subscription offer; and displaying the product subscription offer to a commerce user interface on a customer client device communicatively coupled to the e-commerce platform, where the product subscription offer is based on evaluating the e-commerce behavior data. In embodiments, the commerce user interface may include an input interface to adjust a subscription parameter. The subscription parameter may be a start time for the subscription offer. The subscription parameter may be a periodicity for the subscription offer. The commerce user interface may include an input interface to accept the product subscription offer. The commerce user interface may include an input interface to request a renewal of an active product subscription offer. The customer prior purchase data may be collected from an email account through which at least one of customer product order information and customer order tracking information is transmitted. The product subscription offer may include an offer for a multiple-time discounted purchase of at least one product based on a purchase schedule. The product subscription offer may include an offer to the customer for a one-time discounted purchase of at least two products.

In an aspect, a system for a user interface may include a merchant client device retrieving e-commerce behavior data from a data facility, where the e-commerce behavior data comprises customer prior purchase data based on a purchase of a product by a customer through an e-commerce platform, the merchant client device configured to store a set of instructions that, when executed, cause the merchant client device to: evaluate the e-commerce behavior data with an analytics engine to determine a plurality of subscription products to offer the customer in a product subscription offer; and display the product subscription offer to a merchant of the e-commerce platform on a commerce user interface, where the product subscription offer is based on evaluating the e-commerce behavior data. In embodiments, the commerce user interface may be presented on a user home page of a merchant online store of an e-commerce platform. The commerce user interface may be presented to a graphical user interface on a merchant client device. The product subscription offer may provide recommendations based on the plurality of subscription products for the customer, wherein the merchant can adjust an analytics parameter for the analytics engine to adjust the recommendations. The product subscription offer may include at least a second merchant, where the product subscription offer comprises opt-in options to the merchant based on the product subscription offer including at least the second merchant. The product subscription offer may include a fulfillment commitment option for the merchant. The plurality of subscription products may include at least two products, where the at least two products are products for sale by the merchant and evaluating the e-commerce behavior data with an analytics engine determines a present value for an e-commerce attribute of the at least two products, and the product subscription offer includes the at least two products. The at least two products may be related by a usage characteristic. The usage characteristic may be the at least two products being used in a functional space within a residence. The functional space may be at least one of a laundry room, a bathroom, a kitchen, an automotive space, or a storage space.

In an aspect, a system may include a merchant client device displaying a commerce user interface for composing a product subscription, the merchant client device configured to store a set of instructions that, when executed, cause the merchant client device to: receive a product subscription request from the merchant client device; retrieve e-commerce behavior data from a data facility based on the product subscription request, wherein the e-commerce behavior data comprises customer prior purchase data based on a purchase of a product by a customer through an e-commerce platform; evaluate the e-commerce behavior data with an analytics engine to determine a plurality of subscription products to offer the customer in a product subscription offer; and display the product subscription offer on the commerce user interface, wherein the product subscription offer is based on evaluating the e-commerce behavior data. In embodiments, the commerce user interface may be presented on a user home page of a merchant online store of an e-commerce platform. The commerce user interface may be presented to a graphical user interface on a merchant client device. The commerce user interface may include an input interface to adjust an analytics parameter for the analytics engine to adjust the evaluating the e-commerce behavior data. The commerce user interface may include an input interface for specifying products for inclusion in the product subscription offer. Evaluating the e-commerce behavior data with the analytics engine may include detecting patterns in products that are being sold by a merchant. Evaluating the e-commerce behavior data with the analytics engine may include detecting patterns in products that are in inventory by a merchant. The customer prior purchase data may be collected from a post purchase care facility that stores customer product purchase information.

In an aspect, a system for a user interface may include a merchant client device retrieving e-commerce behavior data from a data facility, where the e-commerce behavior data comprises customer prior purchase data based on a purchase of a product by a customer through an e-commerce platform, the merchant client device configured to store a set of instructions that, when executed, cause the merchant client device to: evaluate the e-commerce behavior data with an analytics engine to determine a plurality of subscription products to offer the customer in a product subscription offer; and display the product subscription offer to a commerce user interface on a customer client device communicatively coupled to the e-commerce platform, where the product subscription offer is based on evaluating the e-commerce behavior data. In embodiments, the commerce user interface may include an input interface to adjust a subscription parameter. The subscription parameter may be a start time for the subscription offer. The subscription parameter may be a periodicity for the subscription offer. The commerce user interface may include an input interface to accept the product subscription offer. The commerce user interface may include an input interface to request a renewal of an active product subscription offer. The customer prior purchase data may be collected from an email account through which at least one of customer product order information and customer order tracking information is transmitted. The product subscription offer may include an offer for a multiple-time discounted purchase of at least one product based on a purchase schedule. The product subscription offer may include an offer to the customer for a one-time discounted purchase of at least two products.

Certain further aspects of the present disclosure are described as follows, any one or more of which may be present in embodiments described throughout the disclosure. Processing the e-commerce behavior data with the analytics engine may include detecting patterns in purchases by the customer. The e-commerce data may further include customer purchase behavior data of a second customer, where processing the e-commerce behavior data with the analytics engine includes detecting patterns in e-commerce activity by the customer and the second customer. Processing the e-commerce behavior data with the analytics engine may include detecting patterns in products that are being sold by the merchant, detecting patterns in products that are being purchased by the merchant, detecting patterns in products that are in inventory by the merchant, and/or evaluation of a number of product transactions across the e-commerce platform. Customer purchase behavior data may be collected from an order history of the customer, purchases made through an e-commerce platform, a post purchase care facility that stores customer product purchase information, an email account through which at least one of customer product order information and customer order tracking information is transmitted, communications between the merchant and the customer, and/or through tracking customer purchase behavior through an e-commerce platform. Merchant commerce data may be collected from a merchant online store, a merchant catalog, a merchant inventory, transactions across the e-commerce platform, and/or through tracking merchant e-commerce behavior through an e-commerce platform. Transmitting the subscription offer to the merchant may include a recommendation for the merchant to offer the subscription offer to the customer, be further sent to the client based on a subscription recommendation approval attribute set by the merchant, sent to a merchant user interface on a merchant client device where the merchant user interface comprises at least one functional control aspect that approves the subscription offer and further transmits the subscription offer to the customer, to a merchant user home page through an online store of an e-commerce platform where the merchant user home page interface comprises at least one functional control aspect that approves the subscription offer and further transmits the subscription offer to the customer, and/or to the merchant by a subscription recommendation engine based on e-commerce patterns detected by the processing of the e-commerce behavior data. The subscription offer may include an offer for a one-time discounted purchase of the at least one product and/or for a multiple-time discounted purchase of the at least one product based on a purchase schedule. The at least one product may include at least two products, where the at least two products are products for sale by the merchant and the processing of the e-commerce behavior data with an analytics engine determines a present value for the e-commerce attribute of the at least two products and the generated subscription offer includes the at least two products. The at least two products may be related by a usage characteristic, such as where the usage characteristic is the at least two products being used in the same functional space within a residence, where the functional space is a laundry room, a bathroom, a kitchen, is an automotive space, and/or a storage space. The e-commerce behavior data with the analytics engine may determine a time correlation with respect to the customer purchasing the at least two products. The subscription offer may include an offer to the customer for a one-time discounted purchase of the at least two products. The subscription offer may include an offer to the customer for a multiple-time discounted purchase of the at least two products based on a purchase schedule. The e-commerce data may further include customer purchase behavior data of a second customer, wherein the subscription offer comprises a cost discount value and sales schedule for the at least one product as offered from the merchant to the customer and the second customer. The subscription offer may further include a commerce guarantee to the merchant based on processing the e-commerce behavior data with the analytics engine and/or a commerce insurance to the merchant based on processing the e-commerce behavior data with the analytics engine. The at least one product may be purchased by an e-commerce platform as a result of determining the present value for the e-commerce attribute of at least one product. The purchased at least one product may be geographically stocked based on the processing of the e-commerce behavior data to optimize a distribution characteristic, such as where the distribution characteristic is delivery time to the customer.

### BRIEF DESCRIPTION OF THE FIGURES

FIG. 1 depicts an embodiment of an e-commerce platform.

FIG. 2 depicts an embodiment for a home page of an administrator.

FIG. 3 depicts a functional block diagram for the e-commerce platform with facilities for building and maintaining subscriptions in an embodiment of the present disclosure.

FIG. 4 depicts a functional block diagram for the e-commerce platform with facilities for generating a product subscription offer in an embodiment of the present disclosure.

FIG. 5 depicts an example flow diagram for a subscription recommendation in an embodiment of the present disclosure.

FIG. 6 depicts an example flow diagram for a merchant receiving a subscription recommendation in an embodiment of the present disclosure.

FIG. 7 depicts an example merchant user interface for a merchant subscription offer recommendation including a single product being presented to a merchant in an embodiment of the present disclosure.

FIG. 8 depicts an example merchant user interface for a merchant subscription offer recommendation including multiple products being presented to a merchant in an embodiment of the present disclosure.

FIG. 9 depicts an example merchant user interface for a merchant subscription offer recommendation including at least one product from a second merchant being presented to a first merchant in an embodiment of the present disclosure.

FIG. 10 depicts an example customer user interface for a customer subscription offer including a single product being presented to a customer in an embodiment of the present disclosure.

FIG. 11 depicts an example customer user interface for a customer subscription offer including multiple products being presented to a customer in an embodiment of the present disclosure.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

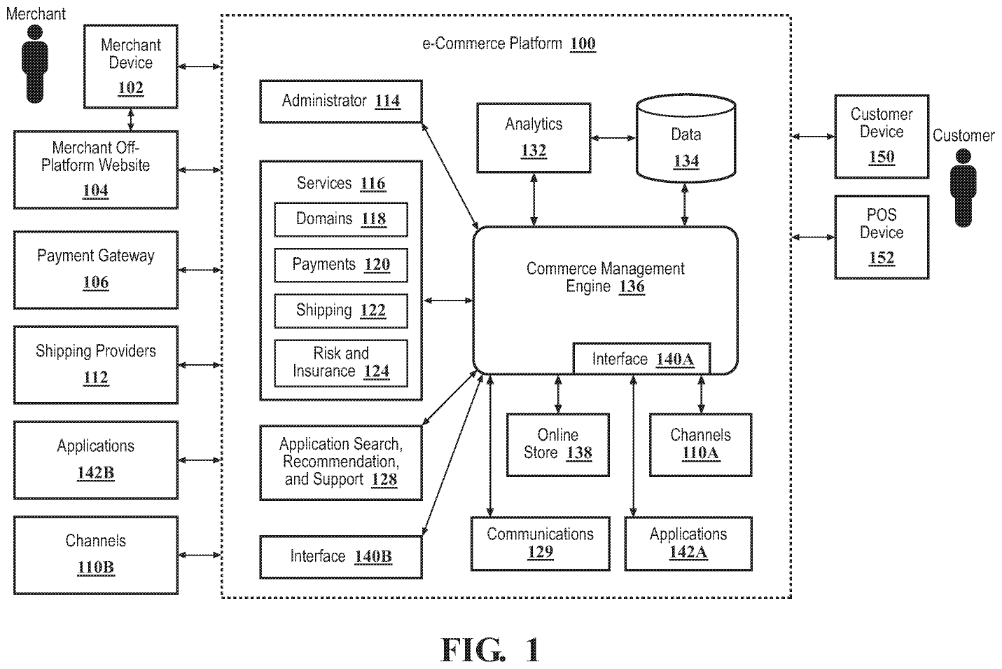

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

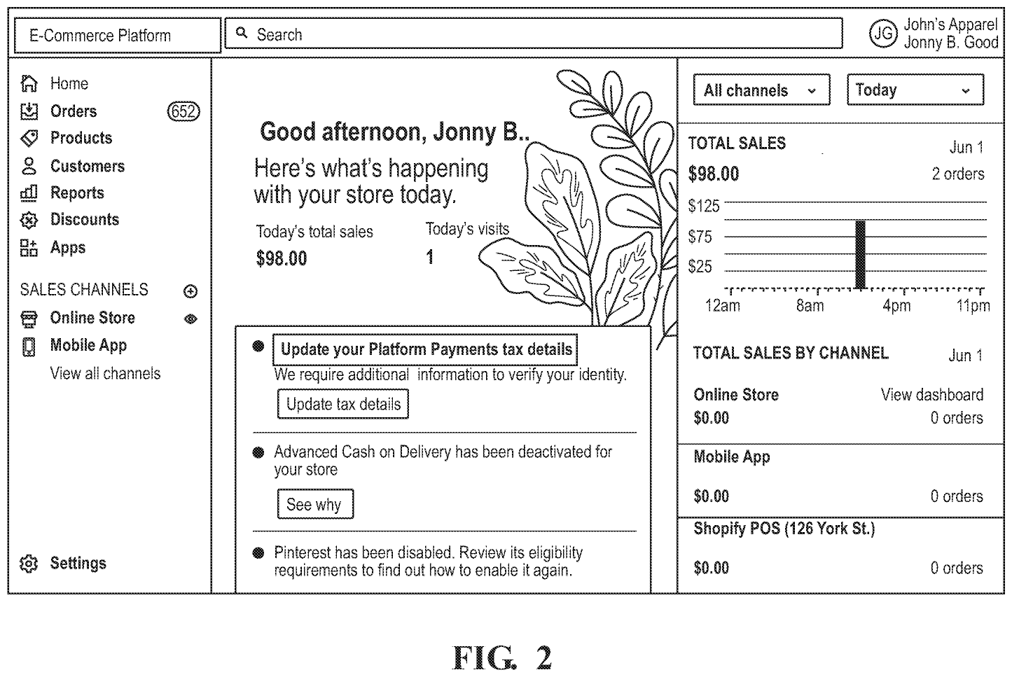

FIG. 2 depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

In embodiments, the e-commerce platform 100 may provide a post-product care facility, which consolidates a user's purchases, including those that were shipped, in one place and makes it easy to obtain updates on status, interact with customer service, and provide post shipment care, such as in association with tracking (and issues), re-routing shipments, returns of products (and issues), re-purchasing, leaving reviews (e.g., connected into an e-commerce platform review application), order history, recommendations, customer support, insurance, and the like. In embodiments, purchase and shipment information may be collected from users through the post-product care facility, such as through purchase and shipment information collected from a customer, such as through order history, at checkout (e.g., across the online store 138) such as through order history, at checkout across the e-commerce platform 100, through an e-commerce platform payment system, through a payment processor, and the like. For instance, a user's email may be parsed and analyzed (e.g., with a user's permission) such as through targeted searching or scanning with natural language processing to understand the content and identify relevant items of orders, shipping, invoice emails, customer support emails, communications with a merchant, communications about a product, and the like. For example, a user's email account may be searched for emails containing a shipping notification with a tracking number, and from that notification it may be possible to determine the relevant items being shipped, when they were delivered, to where and the like. In embodiments, shipment information may be obtained from third-party sources (e.g., through third-party commerce platforms, third-party payment platforms and processors, and the like), directly through use of the e-commerce platform 100 (including a post-product care facility), and the like, for automatically adding shipments to a user's list of tracked shipment items.

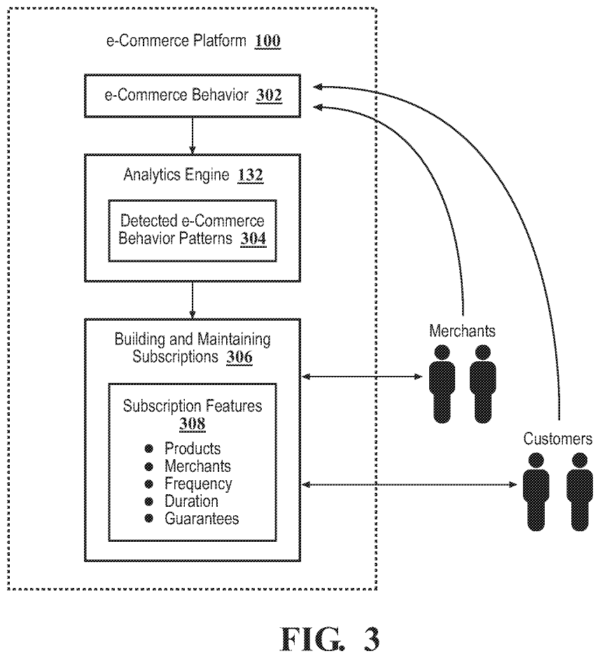

Referring to FIG. 3, in embodiments the e-commerce platform 100 may support building product subscription offers based on e-commerce behavior 302, where e-commerce behavior data is processed by the analytics engine 132 to detect e-commerce behavior patterns 304 (e.g., patterns in individual customer purchases, group of customer purchases, individual sales of merchant, what is selling across merchants, what a merchant is buying, what a group of merchants are buying, and the like) to build and maintain product subscriptions 306 for customers, such as to provide discounts to customers on products for which they already have an established pattern of purchases (e.g., automatically receive products at an established rate of consumption), to merchants to help them establish product purchase habits with customers to provide more predictable business flow (e.g., automatically sell products at an established rate over time), and the like. Subscription features 308 may include subscription information, such as products (e.g., one or more products from a merchant or group of merchants), information about merchants participating in the subscription (e.g., a merchant name, logo, tag line, or geographic location as part of communications to the customer, or agreements between merchants and the like), guarantees (e.g., guarantee agreements between merchants, guarantee agreements between the e-commerce platform and a merchant(s), and the like), or other information related to the generation and maintenance of a subscription. Subscription features 308 may include different subscription dimensions, such as products for the subscription, frequency of delivery for the products of the subscription (e.g., once per month, once per season, once per year, and the like), duration of the subscription (e.g., the subscription lasts for six months, one year, or until turned off by the customer), and the like. Determining subscriptions based on individual customer behavior may increase the probability that a subscription offer will be successful, which has benefits to both the merchant and to the customer.

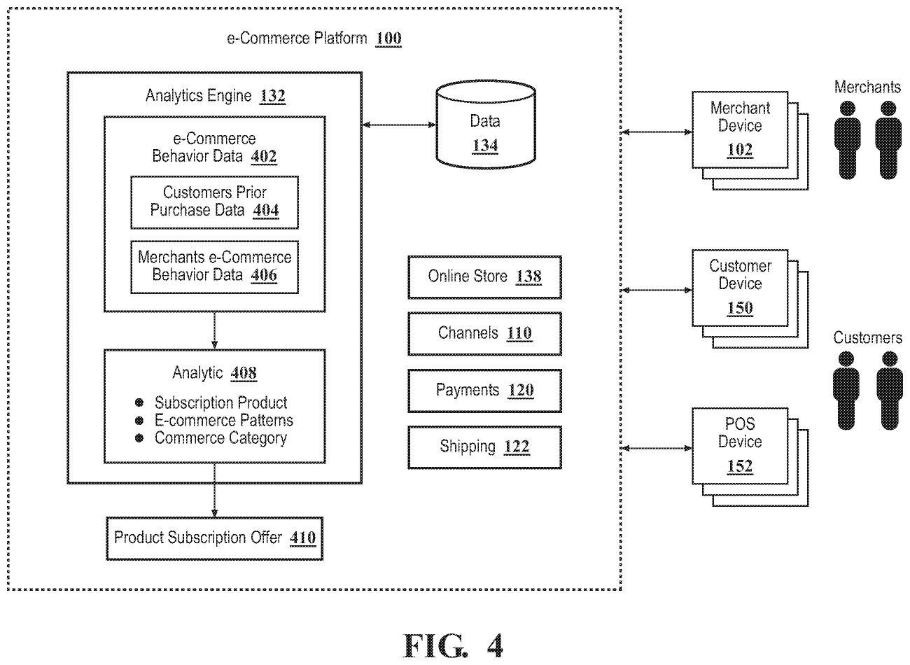

Referring to FIG. 4, the e-commerce platform 100 may collect e-commerce data from a data facility 134, such as from interactions with customers (e.g., prior purchase data, such as associated with a customer purchase parameter) and merchants (e.g., prior sales data, such as associated with a merchant purchase parameter, merchant buying data, product transactions, and the like), such as through data transfers associated with a customer device 150, a POS device 152, a merchant device 102, the online store 138, channels 110, payments 120, shipping 122, and the like. E-commerce data from the data facility 134 may be utilized by the analytics engine 132 to determine e-commerce behavior data 402 associated with customer purchase data 404 (e.g., products purchased, products placed in a virtual shopping cart but not purchased, or products browsed (e.g., in an on-line store 138 or on a merchant off-platform website 104)), merchant e-commerce behavior data 406 (e.g., products sold, products purchased, product inventory, or products listed in a catalog) and the like, to determine an analytic 408 (e.g., subscription product, purchase pattern, commerce category, and the like) through which a product subscription offer 410 may be generated. For simplicity the description herein will refer to subscriptions, but references to subscriptions throughout this disclosure should also be understood to be references to subscriptions of one product or to more than one product (where a subscription of more than one product may also be referred to herein as a bundle), subscriptions from one merchant or that span products from more than one merchant, subscriptions that are a one-time event/purchase or with a given frequency over a given period of time, and the like.

In embodiments, the e-commerce platform 100 may build subscriptions based on detected commerce behavior patterns (e.g., user purchases or tracking a product), such as presented to a merchant, group of merchants, consumer, group of consumers, and the like. For instance, the analytics engine 132 may evaluate e-commerce data (e.g., purchase behavior data of a customer, merchant commerce data of a merchant, and the like) as retrieved from the data facility 134, and generate a subscription based on a threshold value for a product characteristic (e.g., number of products purchased, sold, in inventory, and the like), a pattern detected in the e-commerce data (e.g., customer or merchant commerce behavior associated with product sales), a customer or merchant characteristic (e.g., trends in behavior), a commerce category (e.g., a room or activity space in a home or business), and the like, where a subscription may be presented to the merchant as a recommendation for a product subscription to offer to a customer, group of customers or generally, such as through a user interface for a merchant offering a subscription based on customer purchase behavior. In an example, the analytics engine 132 may process e-commerce data received from the data facility 134 based on setting a threshold value for an e-commerce attribute related to products for sale by the merchant (e.g., number of times the customer has purchased the at least one product, number of the at least one product currently in inventory for the merchant, number of the at least one product that is sold by the merchant, number of the at least one product sold across the e-commerce platform, and the like), where processing the e-commerce data with an analytics engine 132 determines a present value for the e-commerce attribute of at least one product, where if the present value exceeds the threshold value then a subscription offer is generated for the at least one product, where the subscription offer may include a cost discount value, sales schedule, and the like for the at least one product as offered from the merchant to the customer. The subscription offer may then be transmitted and presented to the merchant (e.g., as a subscription offer recommendation presented through a merchant user interface e.g. in the administrator 114), such as for the merchant to offer the subscription offer to the customer, based on a subscription recommendation approval attribute set by the merchant (e.g., a merchant approving, enabling, editing, and the like, the subscription offer recommendation), and the like.

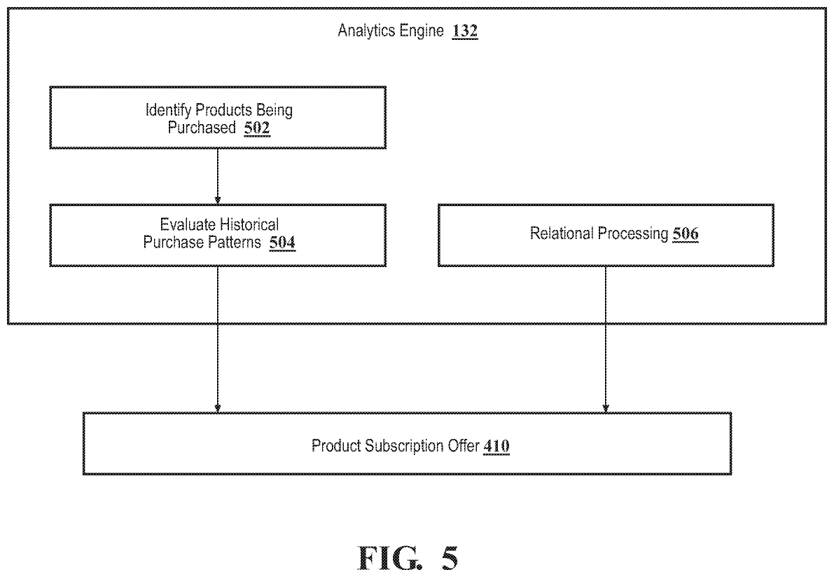

Referring to FIG. 5, in embodiments the analytics engine 132 may, in a first processing step 502, identify products that are being purchased, such as through commerce purchases (e.g., language processing of product names and/or descriptions, or vision system processing of images associated with the purchase), communications (e.g., language processing of customer communications related to product discussions or language processing of merchant communications related to retail product sales or wholesale product purchases), and the like. For instance, customers may be buying detergent, and the analytics engine 132 determines through language and/or vision processing whether the detergent is for a dishwasher in the kitchen or for a washing machine in the laundry room. In this way, the analytics engine 132 may constantly evaluate and identify products for potential subscription offers, such as based on evaluation of purchase patterns for a plurality of merchants and/or customers, a specific merchant or group of merchants, a specific customer or group of customers, or any combination of general merchant and/or customers and specific merchant and/or specific merchants. Further, the analytics engine 132 may identify generic products or product types, classes or categories from specific brand products, such as identifying that laundry detergent (e.g. a product type) is being regularly purchased in general vs. a specific brand of laundry detergent. In embodiments, the analytics engine 132 may then incorporate that information into subscription offer recommendations (e.g., offering a customer or group of customers a choice of brands or a specific brand, depending on the goals of the merchant related to targeted brands and product bundling). In embodiments the analytics engine 132 may, in a second processing step 504, evaluate historical purchase patterns across customers and/or merchants to determine if they have a purchase pattern for an identified product (or type of product) that may be accommodated through a subscription offer. For instance, if the analytics engine 132 identifies laundry detergent as a product being purchased, and determines based on historical purchase data across customers and/or merchants that laundry detergent is a type of product suitable for purchase on a subscription, the analytics engine 132 may present a merchant of laundry soap with a recommendation to offer it on a subscription basis. In another embodiment, if the analytics engine 132 identifies laundry detergent as a product being purchased, and determines that a specific customer has historical purchase patterns that reveal the customer purchases laundry detergent once every two months on average, the analytics engine 132 may present a merchant of laundry soap with a recommendation to offer that customer a subscription offer for laundry detergent. In another embodiment, the analytics engine 132 may first evaluate a plurality of customer and/or merchant purchase patterns to identify potential products (or product types) for inclusion in a subscription offer, and then evaluate a specific customer or merchant (or specific group of customers and/or merchants) to determine if the identified products apply to the specific customer(s) and/or merchant(s). In this way, the analytics engine 132 may create subscription offers based on data across a broad number of users as well as on the specific purchasing patterns of an individual or group of individuals. Further, in a third processing step 506, the analytics engine 132 may associate products with related products through relational processing. For instance, if the analytics engine 132 determines the detergent is laundry detergent, relational processing may determine that customers often also purchase dryer sheets for the dryer in the laundry room, and that laundry detergent and dryer sheets may be bundled together in a recommendation associated with the laundry room (e.g., along with other like products, such as products for spot treatment). The analytics engine 132 may generate recommendations for bundles of products for subscriptions in general corresponding to categories or in association with particular products or may review historical purchase patterns for a given customer to determine if the customer has a purchase pattern for the related products, and if so recommend to the merchant to offer the product and related product(s) in a bundled subscription offer to the customer (e.g., laundry detergent plus dryer sheets in a subscription with periodicity determined from the historical purchase patterns of one or both of the laundry detergent and the dryer sheets).

Offering subscriptions to customers may not only benefit the customer (e.g., discounted rates and/or saving time spent in re-orders of regularly purchased products) but may also reduce a processing burden on the merchant. For instance, subscriptions may reduce resources expended on marketing to repeat customers, as the repeat customers now have a mechanism to automatically re-order products. In another instance, the merchant may reduce resources expended in shipping products, such as through combining products in one shipment, shipping similar products or bundles of products to a group of customers on a periodic basis, and the like. For example, the subscription offer recommendation may optimize the shipment of laundry detergent to a group of customers based on historical purchase patterns for the group of customers such that the merchant minimizes the time spent on packaging and shipping the laundry detergent to the group of customers, thus reducing resources expended for this activity. In this way, subscription offer recommendations may not only improve the reliability of purchases with the group of customers but also reduce the resources expended in servicing the group of customers (e.g., marketing, shipping, communications with customers, and the like). The analytics engine 132 may also simplify for merchants the process of identifying subscription opportunities, as well as the number of dimensions to be determined by the merchant or customer relating to a subscription opportunity. For example, the analytics engine 132 may automatically determine the optimal frequency for delivery for a subscription of a bundle of products to minimize the shipping costs for the merchant. In this manner, the subscription options presented to merchants and customers may be greatly simplified, avoiding the need for detailed manual customization by merchants and customers.

In embodiments, the merchant interface may provide an interface with the analytics engine 132 for the merchant, where the analytics engine 132 recommends products and subscriptions for a customer, group of customers or generally, and where the merchant may adjust the recommendation engine parameters and output as well as adjusting the recommendations to be offered to the customer, group of customers or generally. A subscription may also be presented to or in association with a group of merchants, such as presenting different products (i.e., a ‘bundled’ subscription) from different merchants where the different merchants have the option to opt-in to the subscription offer. In embodiments, products amongst merchants may be combined that complement each other in a non-competitive way, such as where similar products from different merchants don't pit merchants against one another in a competitive fashion. For example, a subscription from a group of merchants may include soap from a first merchant and toilet paper from second merchant in a ‘washroom venue subscription’. In embodiments, building a subscription involving a group of merchants may be through the group of merchants working together (e.g., where the e-commerce platform initiated the idea for the subscription through a subscription recommendation), where the e-commerce platform 100 builds the subscription in its entirety for presentation to the group of merchants, or through a blended process where the merchants work with the e-commerce platform 100 to build the subscription (e.g., through the user interface with the analytics engine 132). The subscription may then be presented to a customer recommending that they consider the subscription offer. Further, the subscription may be offered to a group of customers, such as where a group of customers may have more purchasing power when buying together.

Commerce behavior patterns may be detected through patterns in an individual customer's purchases, patterns in a group of customers' purchases, patterns in customer purchases across the e-commerce platform 100, patterns in what an individual merchant is selling, patterns in what is selling across different merchants, patterns in what a merchant is purchasing for sale and/or across the supply chain of the merchant, patterns in a group of merchants' purchases, patterns of what merchants are buying and/or selling across the e-commerce platform 100, and the like. For instance, detecting patterns in an individual customer's purchases and the like (or for similar users) may be used to offer subscriptions for that user, such as based on direct purchases or on how the customer responds to product recommendations from the e-commerce platform 100, based on certain purchase patterns over a time period (e.g., purchases made over a couple of days (e.g., buying a second identical product after two days) may not be reason to generate a subscription, but purchases every three months may), based on purchases with respect to certain product types (e.g., some products may not be candidates for a subscription (e.g., occasionally purchasing a sweater), but others may be (e.g., periodically purchasing running socks)), and the like.

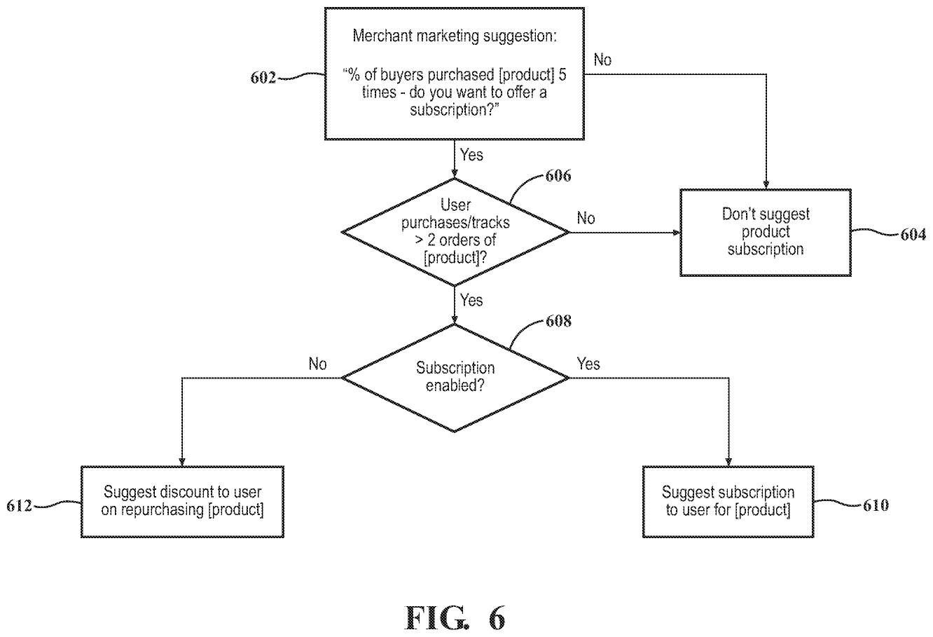

In embodiments, a pattern detection algorithm may factor in a product type (e.g., such as through natural language processing on the product title to detect ‘what it means to be a blue shirt’), product sales volume, product inventory, number of customer purchases for a given product, customer purchases over a period of time, and the like, and then offer a customer subscription recommendation to a merchant or otherwise. In an example, and referring to FIG. 6, in a first step 602 a merchant marketing suggestion may be sent to a merchant that a “percent of buyers purchased the product five times—do you want to offer a subscription or discount?” If the merchant decides to not offer a subscription or discount the process flow may proceed to step 604 where no product discount or subscription is suggested. If the merchant decides to offer a subscription (or discount) the process flow may proceed to step 606 where a subscription parameter is assessed, which in this instance is determining if a specific user ordered the product more than two times (e.g., as determined through client purchase tracking). If not, then the process flow again proceeds to step 404 where no product discount or subscription is suggested. If the specific user has ordered the product more than two times, the process flow may proceed to step 608 where it is determined whether a subscription preference is enabled or not (e.g., as a default, as determined by a merchant action, and the like). If the subscription preference is enabled the process flow may proceed to step 610 where a subscription is suggested to the user for the product. If the subscription preference is disabled, then the process flow may proceed to step 612 where a discount is offered.

Commerce behavior patterns may be detected by the analytics engine 132 through patterns in merchant behavior, such as in detecting patterns in what an individual merchant is selling, where a merchant may be informed of potential subscription offers for customers related to the merchant's detected behavior patterns. The analytics engine 132 may also consider data from other merchants and sources, as well as from client behavior with respect to the merchant, such as based on direct purchases by customers or on how the customer responds to product recommendations. Patterns may also be detected based on what is selling across different merchants, such as a specific group of merchants, across all merchants of the e-commerce platform 100, and the like. Merchant-based pattern detection may be based on various merchant parameters, such as sales (e.g., past sales, current sales volume, projected sales), product availability, product inventory, product catalogs, reputation (e.g., on social media, industry ratings, and the like), location of products (e.g., physical locations for manufacturers, warehousing, and the like), product fulfillment (e.g., whether the sale was fulfilled through the e-commerce platform), and the like. Patterns in merchant behavior may include what the merchant is purchasing, stocking (e.g., volume of product on hand), as well as product aspects along the supply chain for the merchant, and the like. Patterns for groups of merchants may also be evaluated, where in embodiments, merchant and customer data from across the e-commerce platform 100 may be made anonymous, such as to maintain data insulation between merchants.

Customer and merchant behavior may be tracked based on product purchase/sales behavior, residence/business address, mobile usage, geography, demographics, and the like, such as for individuals or groups of customers and merchants. In embodiments, a user may be required to approve tracking in order to allow the e-commerce platform 100 to use information in determining behavior patterns. In embodiments, tracking (such as with the permission of the user) may extend beyond the bounds of the e-commerce platform 100, such as to third-party commerce providers, shipping providers, payment providers, and the like. In embodiments, tracking customer and merchant behavior may be provided, including whether tracking is with knowledge of the customer or merchant for consideration of subscription analysis, such as tracking for individual customers or groups of customers, tracking for individual merchants, tracking across merchants for related products (e.g., when a group of merchants have agreed to collaborate), tracking without the merchant's knowledge, and the like. For instance building a group merchant offer may be based on detected patterns across a group of merchants that have agreed to collaborate, such where the offer targets an individual customer, a group of customers, class of customers, and the like.

Presentation of a subscription offer may be presented as a recommendation to the merchant. Although subscription offers may be presented directly as such, product subscriptions may be presented to a merchant through a recommendation engine, such as based on any of the patterns listed herein, targeting best customers (e.g. to systematize the purchases from regular customers, which in turn help keep them as customers), making the satisfied customer even more satisfied, targeting new or occasional customers (e.g., to help capture them as repeat customers, or make an occasional customer a more regular customer), and the like.

A product subscription may have offer characteristics, such as with respect to composition of products (e.g., multiple products from a merchant or multiple products from multiple merchants), frequency at which the subscription products are supplied (e.g., one item for one time, one item for multiple times, a bundle for one time, or a bundle for multiple times), duration over which the subscription is provided (e.g., a set term, such as a minimum term to get a certain price or an expected end date (e.g., for diapers and baby supplies), or until the subscription is cancelled), time correlation (e.g., relating time of purchase between at least two products), and the like. A group of products presented in a subscription may be bundled as related products, such as grouped by product type, product theme, usage profile, usage characteristic, and the like. Alternately, a group of products may be only loosely related, such as not being related other than by the fact that there was some advantage to bringing them together, such as by a particular consumer or more generally. The analytics engine 132 may determine a composition of products for a subscription, and make a recommendation to a merchant, such as where the merchant could send the recommended subscription to a customer with a note, such as “We [specifying the merchant] noticed you are buying products for the laundry room—here are some other products that may be useful based on patterns with respect to past purchases.” Bundled products in a subscription may include a thematic grouping, such as with some common link (e.g., being in a category or for a particular room, and the like). For instance, a bundled product theme may focus the subscription on a room (e.g., a bathroom theme, such as for soap, paper products, cosmetics, and the like, or a kitchen theme, such as for food, storage items, based on a menu, prepared foods, and the like), a season (e.g., yard products, automotive products and service, seasonal clothing, and the like), a sport (e.g., golf balls, bicycle products, and the like), or any other theme.

In embodiments, the e-commerce platform 100 may provide services related to the building and offering of subscriptions, such as offing guarantees to merchants related to sales of a presented subscription (e.g., guarantees for sales over a period of time, such as guaranteeing a product at a discounted price ‘x’ to sell ‘y’ units by date ‘z’ where the merchant agrees to related fulfillment obligations, fulfillment commitment options, and the like), insurance (e.g., presenting guarantees in the form of insurance), providing subscriptions directly to customers, determining an optimal location for product warehousing (e.g., based on geolocation commerce patterns), and the like. For instance, the e-commerce platform 100 may build and offer subscriptions based on analytics 408 and offer them to users, such as offering them through a sales application directly to customers (e.g., in a one-time sale to take advantage of detected commerce patterns, such as geographically pre-stocking a product in a warehouse for availability in a flash sale to optimize a distribution characteristic).

Product subscriptions generated by the analytics engine 132 (e.g., from evaluating e-commerce behavior data retrieved from the data facility 134) may be displayed through a graphical user interface to a merchant, such as on a merchant device 102. In embodiments, a merchant user interface may be provided, such as for the e-commerce platform 100 prompting merchants to offer recommended subscriptions (e.g., with products in the subscription, related products, customer purchase pattern representations, and the like), communication from the e-commerce platform 100 to merchants presenting demand over time (e.g., where the merchant can opt in if they want, such as to meet the demand level over time), communications from merchants to customers with respect to subscription offers (e.g., automatically sent, such as with a predetermined response to customer interaction, or manually, such as where the merchant engages with the customer one-on-one), and the like. Prompting merchants for offering subscriptions may be triggered in relation to a set threshold, such as offering a subscription to a customer that purchases an item a certain number of times, and then presenting the prompt to the merchant through a merchant home page, such as through virtual information cards presented to the merchant. For example, the virtual information card may state “we noticed this pattern related to a potential multiple product offering”, and then show the merchant the product, and ask the merchant if they are interested in offering the product in a subscription. Further, the product purchase pattern may include multiple products, where at least one of the products purchased by the customer through another merchant. In this instance the merchant may be asked whether they are interested in bundling with another merchant, such as in “Here are ten products from these five merchants—do you want to be included in the subscription offer?” In this way the merchant user interface may provide subscription parameter settings that the merchant may alter, such as the conditions that must be met before a subscription is built (e.g., greater than ‘x’ purchases), patterns that lead to a subscription (e.g., pattern related to a potential multiple product offering), conditions under which the merchant would be interested in bundling with other merchants (e.g., never, always, if there is no competitive overlap with the other merchant(s), a minimum profit margin met, and the like).

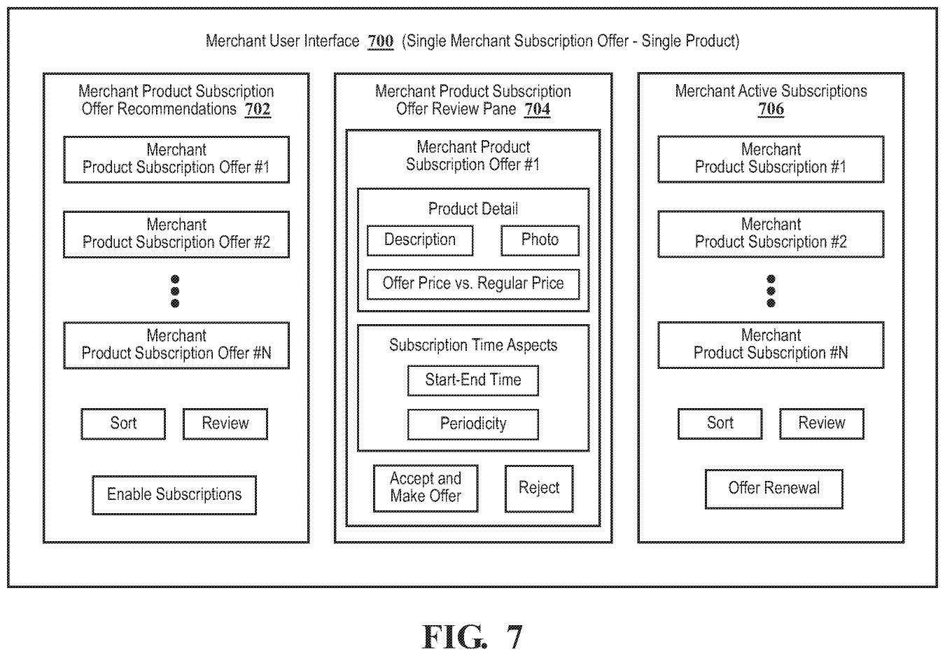

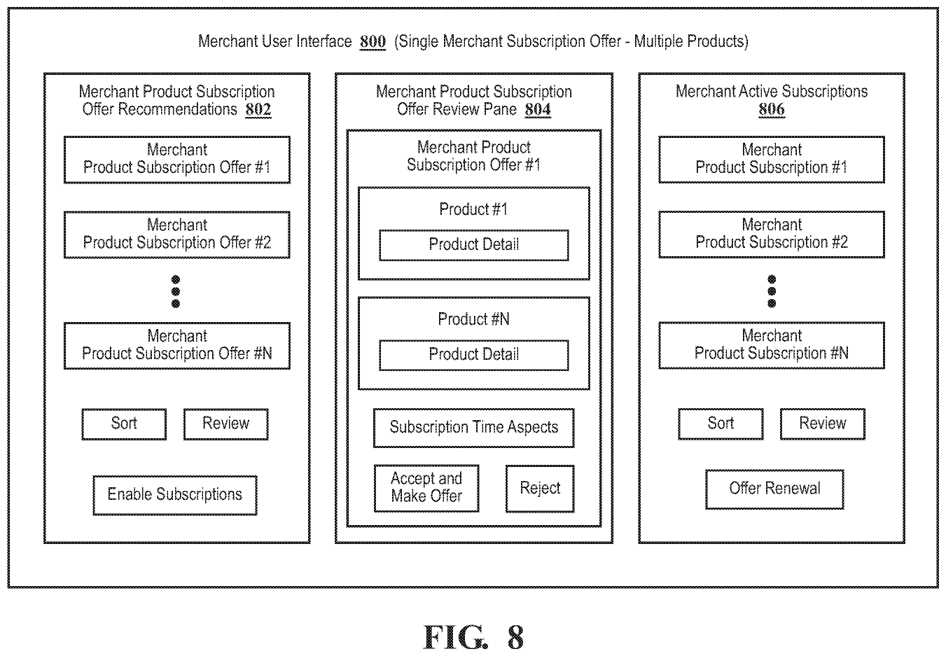

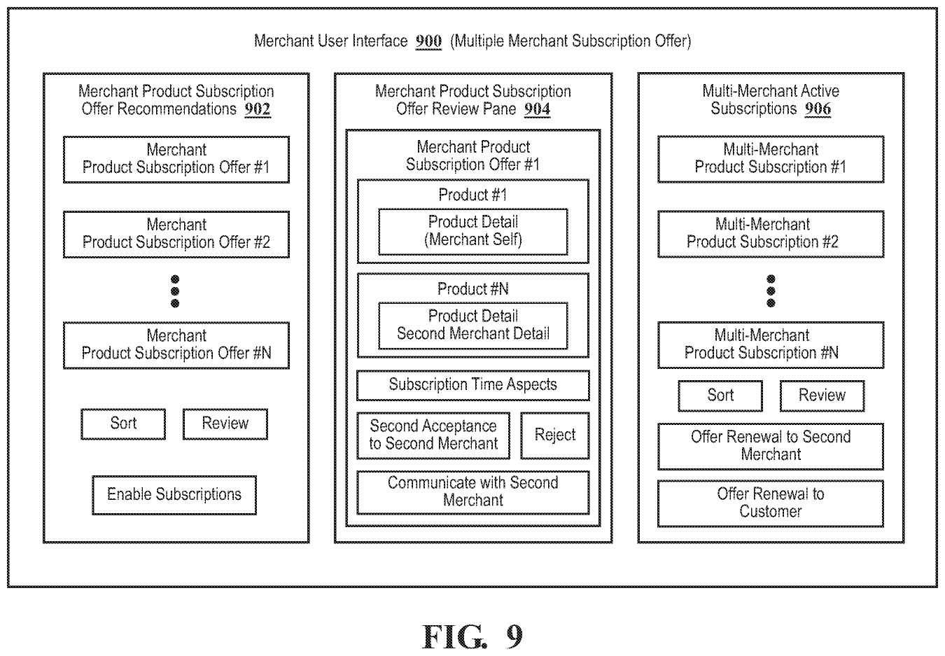

In embodiments, a merchant user interface may provide a merchant with a view of subscription offers, details of offers, pending offers, and the like, such as with controls for reviewing, accepting, and rejecting offers. Referring to FIG. 7, a non-limiting example merchant user interface 700 is presented that illustrates a single merchant subscription offer of a single product. A merchant product subscription offer recommendations 702 pane illustrates a number of merchant product subscription offers being presented to the merchant along with functional controls for sorting offers (e.g., by date, by potential monetary value, by potential product volume impact, and the like) and reviewing specific offers. A functional control is also illustrated for enabling subscriptions, such as to provide a merchant with the ability to turn on and off the function of presenting subscription offers to the merchant. A merchant product subscription offer review pane 704 illustrates details for a selected subscription offer, such as selected from either the merchant product subscription offer recommendations 702 pane or the merchant active subscriptions 706 pane, where the detail illustrated includes product detail (e.g., product description, product image, the offer price vs. the regular price, and the like), and subscription time aspects (e.g., start-end time for the subscription, periodicity for the offer (e.g., how often products are delivered), duration of the offer, and the like). Functional controls are also illustrated for accepting an offer (e.g., accepting and transmitting the offer) and rejecting the offer. A merchant active subscriptions 706 pane illustrates active offers that the merchant has with customers, such as for a number of merchant product subscriptions and functional controls for sorting or reviewing the offers, as well as for offering a customer a renewal offer for the current product subscription. In embodiments, merchant product subscription offer recommendations 702 (as well as 802 and 902 of FIG. 8 and FIG. 9, respectively) and merchant active subscriptions 706 (as well as 806 and 906 of FIG. 8 and FIG. 9, respectively) may include a mix of single product, multi-product, and multi-merchant subscriptions together, such as sortable by type. Referring to FIG. 8 a non-limiting example merchant user interface 800 is presented that illustrates a single merchant subscription offer for multiple products, where illustrated offer recommendations in pane 802 is similar to 702 of FIG. 7 and active subscriptions in pane 806 is similar to 706 of FIG. 7. A merchant product subscription offer review pane 804 illustrates details for a selected subscription offer including multiple products, such as illustrating product detail for a number of products. Referring to FIG. 9 a non-limiting example merchant user interface 900 is presented that illustrates a multi-merchant subscription offer for products, where the illustrated offer recommendations in pane 902 is similar to 702 of FIG. 6 and active subscriptions in pane 906 is similar to 706 of FIG. 7. A merchant product subscription offer review pane 904 illustrates details for a selected subscription offer including merchant detail for the different merchants offering the different products. Additionally, a functional control is illustrated for communicating with the other merchants involved in the multi-merchant subscription offer.

In embodiments, a merchant may be provided a commerce user interface for composing a subscription in conjunction with the capabilities of the analytics engine 132. For instance, the commerce user interface may display an interface for composing and sending a product subscription request to the analytics engine 132, where the analytics engine 132 retrieves e-commerce behavior data 402 from the data facility 134 based on the product subscription offer request, where the e-commerce behavior data 402 comprises customer prior purchase data 404 based on a purchase of a product by a customer through the e-commerce platform 100. The analytics engine 132 may then evaluate the e-commerce behavior data 404 to determine a plurality of subscription products to offer the customer in a product subscription offer 410, and send that information back to the merchant for displaying the product subscription offer on the commerce user interface. In embodiments, the commerce user interface may include an input interface to adjust an analytics parameter for the analytics engine to adjust the evaluating the e-commerce behavior data, for specifying products for inclusion in the product subscription offer, and the like.

Product subscriptions generated by the analytics engine 132 (e.g., from evaluating e-commerce behavior data retrieved from the data facility 134) and accepted by a merchant may be displayed through a graphical user interface to a customer, such as on a customer device 150. In embodiments, a customer user interface may be provided, such as for a customer to view subscription offers (e.g., to select products and merchants to which the customer wants to accept subscription offers), provide feedback to subscription offers (e.g., accepting offers, adjusting subscription offer parameters (e.g., time periods, types of products, merchants), communications with merchants for negotiating the conditions and terms of a subscription offer, and the like), requesting adjustments for subscriptions, modifying a subscription (e.g., adding, removing, and changing products, changing the duration or frequency of the subscription, and the like), throttling a subscription rate (e.g., overall subscription rate and for particular products, such as with a speed-up and/or slow-down button), and the like. In embodiments, the customer user interface may provide an interface to a subscription marketplace, such as where customers have access to provide feedback through the subscription marketplace based on their experience with subscriptions. The subscription marketplace may also provide an interface for trading, buying, and/or selling subscriptions amongst other customers.

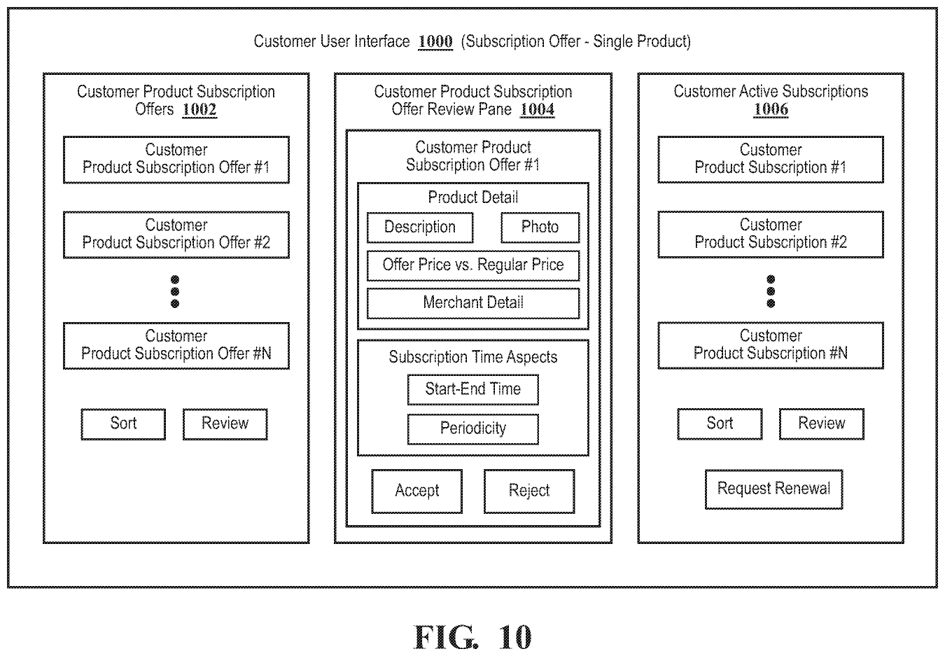

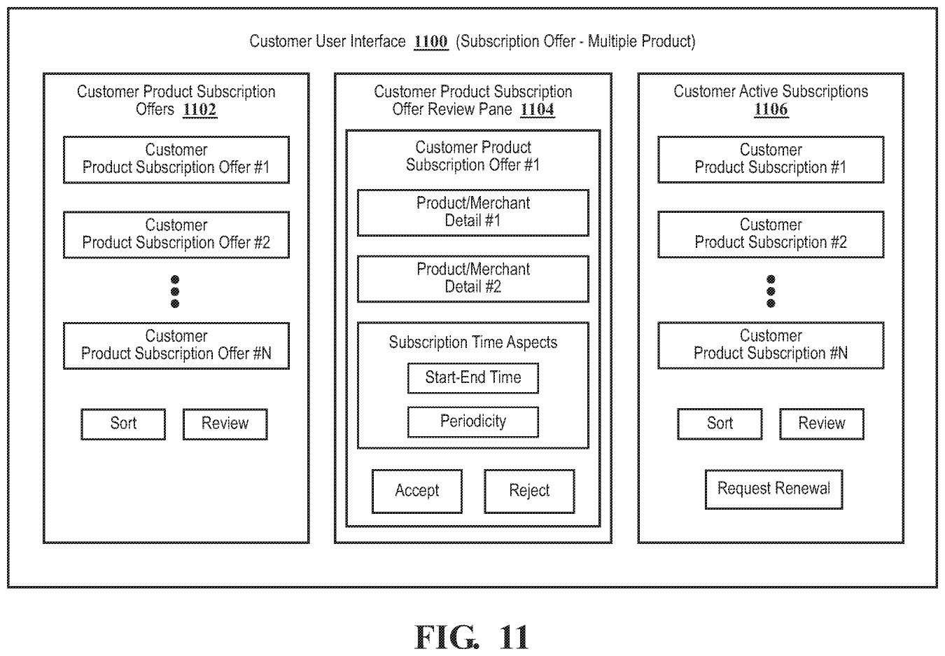

In embodiments, a customer user interface may provide a customer with a view of subscription offers, details of offers, pending offers, and the like, such as with controls for reviewing, accepting, and rejecting offers. Referring to FIG. 10, a non-limiting example customer user interface 1000 is presented that illustrates a single product subscription offer of a single product. Similar to the merchant user interface, the customer user interface illustrates a listing of customer product subscription offers 1002 and a listing of customer active subscriptions 1006. A customer product subscription offer review pane 1004 is illustrated that provides detail for a selected offer, such as selected from the listing of customer product subscription offers 1002 and customer active subscriptions 1006, along with detail information including product detail (e.g., description of the product, image of the product, offer price vs. regular price, merchant information for the merchant offering the product, and the like). Time aspects are also illustrated, subscription time aspects are also illustrated, such as start-end time for the subscription, periodicity for the offer (e.g., how often products are delivered), duration of the offer, and the like. Referring to FIG. 11, a customer product subscription offer review pane 1104 additionally illustrates a customer offer that includes multiple products, where detail information is available for the multiple products.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A computer-implemented method for a user interface, comprising:
displaying a commerce user interface for composing a product subscription, the commerce user interface displayed on a merchant client device;
receiving a product subscription request from the merchant client device;
retrieving e-commerce behavior data from a data facility based on the product subscription request, wherein the e-commerce behavior data comprises customer prior purchase data based on a purchase of a product by a customer through an e-commerce platform;
evaluating the e-commerce behavior data with an analytics engine to determine a plurality of subscription products to offer the customer in a product subscription offer; and
displaying the product subscription offer on the commerce user interface, wherein the product subscription offer is based on evaluating the e-commerce behavior data.

2. The computer-implemented method of claim 1 wherein the commerce user interface is presented on a user home page of a merchant online store of an e-commerce platform.

3. The computer-implemented method of claim 1 wherein the commerce user interface is presented to graphical user interface on a merchant client device.

4. The computer-implemented method of claim 1 wherein the commerce user interface includes an input interface to adjust an analytics parameter for the analytics engine to adjust the evaluating the e-commerce behavior data.

5. The computer-implemented method of claim 1 wherein the commerce user interface includes an input interface for specifying products for inclusion in the product subscription offer.

6. The computer-implemented method of claim 1 wherein evaluating the e-commerce behavior data with the analytics engine comprises detecting patterns in products that are being sold by a merchant.

7. The computer-implemented method of claim 1 wherein evaluating the e-commerce behavior data with the analytics engine comprises detecting patterns in products that are in inventory by a merchant.

8. The computer-implemented method of claim 1 wherein the customer prior purchase data is collected from a post purchase care facility that stores customer product purchase information.

9. A system for a user interface, comprising:
a merchant client device displaying a commerce user interface for composing a product subscription, the merchant client device configured to store a set of instructions that, when executed, cause the merchant client device to:
receive a product subscription request from the merchant client device;
retrieve e-commerce behavior data from a data facility based on the product subscription request, wherein the e-commerce behavior data comprises customer prior purchase data based on a purchase of a product by a customer through an e-commerce platform;
evaluate the e-commerce behavior data with an analytics engine to determine a plurality of subscription products to offer the customer in a product subscription offer; and
display the product subscription offer on the commerce user interface, wherein the product subscription offer is based on evaluating the e-commerce behavior data.

10. The system of claim 9 wherein the commerce user interface is presented on a user home page of a merchant online store of an e-commerce platform.

11. The system of claim 9 wherein the commerce user interface is presented to graphical user interface on a merchant client device.

12. The system of claim 9 wherein the commerce user interface includes an input interface to adjust an analytics parameter for the analytics engine to adjust the evaluating the e-commerce behavior data.

13. The system of claim 9 wherein the commerce user interface includes an input interface for specifying products for inclusion in the product subscription offer.

14. The system of claim 9 wherein evaluating the e-commerce behavior data with the analytics engine comprises detecting patterns in products that are being sold by a merchant.

15. The system of claim 9 wherein evaluating the e-commerce behavior data with the analytics engine comprises detecting patterns in products that are in inventory by a merchant.

16. The system of claim 9 wherein the customer prior purchase data is collected from a post purchase care facility that stores customer product purchase information.
